(19) United States
(12) Patent Application Publication
(10) Pub. No.: US 2024/0218665 A1
(43) Pub. Date: Jul. 4, 2024

(54) STRUCTURAL MODULES PRODUCED BY ADDITIVE MANUFACTURING

(71) Applicant: PPG Industries Ohio, Inc., Cleveland, OH (US)

(72) Inventors: Cynthia Kutchko, Pittsburgh, PA (US); Bryan W. Wilkinson, Pittsburgh, PA (US); Brian Chiang, Pittsburgh, PA (US); Bret M. Boyle, Pittsburgh, PA (US); Jacob M. Kupas, Pittsburgh, PA (US); Thierry L.C. Destruhaut, Amsterdam (NL)

(73) Assignee: PPG Industries Ohio, Inc., Cleveland, OH (US)

(21) Appl. No.: 18/554,026

(22) PCT Filed: Apr. 5, 2022
(86) PCT No.: PCT/US2022/071548

§ 371 Date: Oct. 5, 2023

Related U.S. Application Data
(60) Provisional application No. 63/171,121, filed on Apr. 6, 2021.

(51) Int. Cl. E04B 2/00; B29C 64/118; B29K 75/00; B29K 105/00; B29L 7/00; B33Y 10/00; B33Y 80/00; E04C 2/00; E04C 2/20; E04C 2/38; E04C 2/52

(52) U.S. Cl. CPC E04C 2/46; B29C 64/118; B33Y 10/00; B33Y 80/00; E04C 2/20; E04C 2/388; E04C 2/526; B29K 2075/00; B29K 2105/0002; B29L 2007/002; E04C 2002/001

(57) ABSTRACT

Structural modules may be produced through additive manufacturing. The modules may comprise interconnecting features to couple modules together, structural support members, external layers, and/or integrated electrical connectivity. The modules may be produced through a coreactive additive manufacturing system comprising a movable printing arm and/or a movable table.

### CROSS-REFERENCES TO RELATED APPLICATIONS

This application claims priority to U.S. Provisional Patent Application No. 63/171,121, filed Apr. 6, 2021, which is incorporated herein by reference in its entirety for all purposes.

### FIELD

The present disclosure relates to additive manufacturing compositions and methods and, in particular, related to compositions and methods for manufacturing structural modules such as modular wall panels.

### BACKGROUND

Current construction methods related to structures and buildings often involve laying a foundation, adding a frame, and putting up walls. Often the walls comprise a number of wooden studs secured to the frame and/or foundation, to which drywall or other materials are added. The walls may then be painted, insulated, textured, or otherwise modified to create the final wall structure within a building. The process from laying a foundation to finalizing the walls of a building is often time and labor intensive.

Additive manufacturing or 3D printing involves the deposition of material onto other material to manufacture objects or structures. Additive manufacturing may be used to generate relatively small and/or lightweight parts quickly, but to date has been limited in large-scale production of relatively large articles.

What is needed is an improvement over the foregoing.

### SUMMARY

The present disclosure provides structural modules produced through additive manufacturing, as well as methods for producing the structural modules. The modules may comprise interconnecting features to couple modules together, structural support members, and/or integrated electrical connectivity. The modules may be produced through a co-reactive additive manufacturing system comprising a movable printing arm and/or a movable table.

The present disclosure provides a method of manufacturing a structural module comprising printing a structural module comprising a first surface and a second surface opposite the first surface, wherein the first surface and the second surface are substantially planar; and printing a plurality of structural support members on the second surface and projecting outwardly from the second surface, wherein at least one of the printing steps is carried out by reacting a first reactive component with a second reactive component, and the plurality of structural support members are of a composition chemically different from the first surface.

The present disclosure also provides a structural module comprising a first surface; a second surface opposite the first surface, wherein at least one of the first and second surfaces have an area of at least 6 in²; and a plurality of structural support members coupled to the second surface wherein the first surface, the second surface, and the structural support members, are each composed of a polymer and produced from an additive manufacturing process in which a first reactive compound reacts with a second reactive compound.

The present disclosure also provides a modular wall system comprising a first wall extending from a first end to a second end, the first wall comprising: a first surface; a second surface opposite the first surface of the first wall; a plurality of first structural supports coupled to the first surface of the first wall; and a plurality of first connection features coupled to the first surface of the first wall; and a second wall extending from a first end to a second end, the second wall comprising: a first surface; a second surface opposite the first surface of the second wall; a plurality of second structural supports coupled to the first surface of the second wall; and a plurality of second connection features coupled to the first surface of the second wall; wherein the plurality of first connection features are adapted to couple with the plurality of second connection features proximate the first end of the first wall and the second end of the second wall.

### DESCRIPTION OF THE DRAWINGS

FIG. 1 is a perspective view of a structural module;

FIG. 2 is a front view of the structural module of FIG. 1;

FIG. 3 is a simplified, cross-sectional view of the structural module of FIG. 1;

FIG. 4 is a front view of an electrical circuit of the structural module of FIG. 1;

FIG. 5 is a front view of an electrical outlet of the structural module of FIG. 1;

FIG. 6 is a flowchart for a building process using the structural module of FIG. 1;

FIG. 7 is a flowchart for forming the structural module of FIG. 1;

FIG. 8 is a perspective view of a multi-axis printing arm and a printing bed;

FIG. 9 is a simplified view of a structural framework;

FIG. 10 is a simplified rear-view of an interchangeable façade;

FIG. 11 is a simplified front-view of the interchangeable façade of FIG. 10;

FIG. 12A is a simplified front-view of a façade with a horizontal wood-grain textured surface;

FIG. 12B is a simplified front-view of a façade with a vertical wood-grain textured surface; and

FIG. 13 is a simplified view of connection features.

### DETAILED DESCRIPTION

The present disclosure provides a structural module, and methods of making and using the structural module. The structural module may comprise a main body, a number of support structures, a number of connection features, and an external layer. The structural module may be produced by ambient reactive extrusion additive manufacturing, wherein two components are reacted to form a polymeric structure. The structural module may be produced with a multi-axis printing arm and a printing bed.

### I. Definitions.

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

“Polymer” and “Polymeric” refers to oligomers, homopolymers (e.g., prepared form a single monomer species), copolymers (e.g., prepared form at least two monomer species), terpolymers (e.g., prepared from at least three monomer species), and graft polymers.

“Structural module” refers to any structural unit, for example a modular wall, a wall panel, or a building block.

“Structural support member” refers to any feature or component that may provide structural support to another feature, for example studs or frames.

“Printing” refers to any process in which a material is deposited onto and/or reacted with another material and/or itself, for example three-dimensional printing.

“Connection features” refers to any features or components configured to directly or indirectly couple or connect two or more components together. Connection features may couple/connect components fixedly and/or removably.

“Co-reactive composition” refers to a composition comprising at least two compounds capable of chemically reacting with each other to form covalent bonds.

“Reactive functional group” refers to a chemical group capable of chemically reacting with another reactive functional group to form a covalent bond.

“Reactive compound” refers to a compound comprising at least one reactive functional group.

“Extrusion” refers to a process used to create objects in which material is pushed through a die. An extrusion die has a shape and dimensions suitable to build an object. An extrusion die may have a fixed shape or a shape that can be changed during extrusion.

### II. Ambient Cured Co-Reactive Polymer Formulations.

The present disclosure provides a co-reactive system suitable for use in three-dimensional printing, such as in the printing of structural modules. Any or all of the components of structural modules may be formed from an ambient cured co-reactive polymer formulation. The system may comprise at least two co-reactive components, which may include polymers, prepolymers and/or oligomers. The co-reactive components are reactive with one another, such that the system may be cured at ambient temperature and pressure.

A variety of chemistries may be employed in additive manufacturing of co-reactive components. A co-reactive composition refers to a composition having at least one first component that is reactive with a least one second component. In addition to the first component and the second component, the composition may include other reactive and/or non-reactive components and additives such as fillers, rheology modifiers, adhesion promoters, pigments, and others. For example, the composition may include one or more solid state pigments. The at least one first component may comprise a first functional group and the at least one second component may comprise a second functional group, where the first functional group is reactive with the second functional group. The reaction may proceed without a catalyst.

The first component and the second component may have a single reactive functional group, but generally comprise two or more reactive functional groups such as from 2 to 20 functional groups, from 2 to 16, from 2 to 12, from 2 to 8, from 2 to 6, from 2 to 4, or from 2 to 3 reactive functional groups. The reactive functional groups may be terminal functional groups, pendant functional groups, or a combination of terminal and pendant functional groups.

The first co-reactive component may include compounds having more than one type of functional group A (see Table 1, below), and the second co-reactive component may include compounds having more than one type of functional group B (see Table I, below), such that an additive manufacturing material can comprise at least two sets of co-reactive A and B groups, wherein at least one co-reactive component has a functional group that is saturated. For example, a first co-reactive component may have compounds with hydroxyl groups and secondary amine groups (i.e., at least two different functional groups) and the second co-reactive component may have compounds with isocyanate groups. One or both of the co-reactive components may optionally comprise a catalyst for catalyzing the reaction between the A groups and the B groups.

TABLE 1
Exemplary co-reactive chemistries

| Functional Group A | Functional Group B |
|---|---|
| Carboxylic Acid | Epoxide |
| Activated unsaturated groups such as | Primary or Secondary Amine |
| acrylate, maleic, or fumaric | |
| Isocyanate | Primary or Secondary Amine |
| Isocyanate | Hydroxyl |
| Cyclic Carbonate | Primary or Secondary Amine |
| Acetoacetate | Primary or Secondary Amine |
| Epoxide | Primary or Secondary Amine |
| Thiol | Alkenyl |
| Thiol | Vinyl Ether |
| Thiol | Methacrylate |
| Activated unsaturated groups such as | Malonate |
| acrylate or maleic | |

The first component and the second component can be combined in a suitable ratio to form a curable co-reactive composition. For example, the functional Group A to functional Group B equivalent ratio of a curable composition can be as about 1.0:1.0 or greater, about 1.0:1.2 or greater, about 1.0:1.4 or greater, about 1.0:1.6 or lower, about 1.0:1.8 or lower, about 1.0:2.0 or lower, or about 1.0:1.0 or greater, about 1.2:1.0 or greater, about 1.4:1.0 or greater, about 1.6:1.0 or lower, about 1.8:1.0 or lower, about 2.0:1.0 or lower, or within any range using these endpoints.

Examples of co-reactive compositions may include polyisocyanates and polyamines which react to form polyureas. The reaction of polyisocyanates and polyamines may proceed rapidly at room temperature thereby avoiding the need to control heat flow during deposition. The polyurea reaction may also proceed rapidly in the absence of a catalyst. Other examples of co-reactive compositions may include polyols which react with polyamines to form polyurethanes, polyamines which react with epoxys to form epoxy-amines, and polyamines which react with acrylates to form Michael addition formulations.

The polyisocyanate component may comprise a polyisocyanate prepolymer and/or polyisocyanate monomer and the polyamine component may comprise a polyamine prepolymer and/or polyamine monomer. The polyisocyanate prepolymer and/or polyamine prepolymer can have a number average molecular weight as low as about 500 Daltons, about 1000 Daltons, about 2000 Daltons, about 5000 Daltons, about 7000 Daltons, about 10,000 Daltons, as high as about 11,000 Daltons, about 13,000 Daltons, about 15,000 Daltons, about 20,000 Daltons, or within any range including these endpoints.

### A. Polyurea Compositions.

The isocyanate functional component that may include polyisocyanate monomers and/or prepolymers, or a blend of polyisocyanates. For example, a polyisocyanate prepolymer can be prepared by reacting a polyol prepolymer and/or a polyamine prepolymer with a polyisocyanate such as a diisocyanate. Suitable polyisocyanate prepolymers are commercially available.

Suitable monomeric polyisocyanates may include isophorone diisocyanate (IPDI), which is 3,3,5-trimethyl-5-isocyanato-methyl-cyclohexyl isocyanate; hydrogenated diisocyanates such as cyclohexylene diisocyanate, 4,4′-methylenedicyclohexyl diisocyanate (H₁₂MDI); mixed aralkyl diisocyanates, such as tetramethylxylyl diisocyanates, OCN—C(—CH₃)₂-C₆H₄C(CH₃)₂—NCO; and polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate, and 2-methyl-1,5-pentamethylene diisocyanate.

Suitable monomeric aromatic polyisocyanates may include phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, toluidine diisocyanate and alkylated benzene diisocyanates generally; methylene-interrupted aromatic diisocyanates such as methylenediphenyl diisocyanate, especially the 4,4′-isomer (MDI), including alkylated analogs such as 3,3′-dimethyl-4,4′-diphenylmethane diisocyanate and polymeric methylenediphenyl diisocyanate.

Suitable polyisocyanates also include polyisocyanates prepared from dimers and trimers of diisocyanate monomers. Dimers and trimers of diisocyanate monomers can be prepared, for example, by methods described in U.S. Pat. No. 5,777,061 at column 3, line 44 through column 4, line 40, which is incorporated by reference in its entirety. Dimers and trimers of diisocyanate monomers may contain linkages selected from isocyanurate, uretdione, biuret, allophanate and combinations thereof: such as Desmodur® N3600, Desmodur® CP2410, and Desmodur® N3400, available from Bayer Material Science.

A polyisocyanate may also comprise a polyisocyanate prepolymer. For example, a

polyisocyanate may include an isocyanate-terminated polyether diol, an isocyanate-terminated extended polyether diol, or a combination thereof. An extended polyether diol refers to a polyether diol that has been reacted with an excess of a diisocyanate resulting in an isocyanate-terminated polyether prepolymer with increased molecular weight and urethane linkages in the backbone. Examples of polyether diols include Terathane® polyether diols such as Terathane® 200 and Terathane® 650 available from Invista, or the PolyTHF® polyether diols available from BASF. Isocyanate-terminated polyether prepolymers can be prepared by reacting a diisocyanate and a polyether diol as described in U.S. Application Publication No. 2013/0244340, which is incorporated by reference in its entirety.

A polyisocyanate prepolymer may include an isocyanate-terminated polytetramethylene ether glycol such as polytetramethylene ether glycols produced through the polymerization of tetrahydrofuran. Examples of suitable polytetramethylene ether glycols include Polymeg® polyols (LyondellBasell), PolyTHF® polyether diols (BASF), or Terathane® polyols (Invista).

Polyisocyanate prepolymers may also include isocyanate-terminated polyetheramines. Examples of polyether amines include polyetheramines, such as Jeffamine® (Huntsman Corp.), and polyetheramines available from BASF. Examples of suitable polyetheramines may include polyoxypropylenediamine.

The amine-functional co-reactive component may include primary, secondary, or tertiary amines, or combinations thereof. Examples of suitable aliphatic polyamines include ethylamine, the isomeric propylamines, butylamines, pentylamines, hexylamines, cyclohexylamine, ethylene diamine, 1,3-bis(aminomethyl)diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-dianiinododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

Example of suitable secondary amines may include aliphatic amines, such as a cycloaliphatic diamine. Such amines are available commercially from Huntsman Corporation (Houston, TX) under the designation of Jetfflink® such as Jefflink® 754. Other examples include Clearlink@ 1000 (Dorf-Ketal Chemicals, LLC), and aspartic ester functional amines, such as those available under the name Desmophen® such as NH1220, Desmophen® NH 1420, and Desmophen® NH 1520 (Bayer Materials Science LLC). A secondary amine can be the reaction product of isophorone diamine and acrylonitrile, such as Polyclear® 136 (available from BASF/Hansen Group LLC). A polyamine can also be provided as an amine-functional resin. For example, an amine-functional resin may comprise an ester of an organic acid, such as an aspartic ester-based amine-functional reactive resin that is compatible with isocyanates; e.g., one that is solvent-free, and/or has a mole ratio of amine-functionality to the ester of no more than 1:1 so there remains no excess primary amine upon reaction. An example of such polyaspartic esters is the derivative of diethyl maleate and 1,5-diamino-2-methylpentane, available commercially from Bayer Corporation under the trade name Desmophen® NH1220. Other suitable compounds containing aspartate groups may be employed as well. Additionally, the secondary polyamines can include polyaspartic esters which can include derivatives of compounds such as maleic acid, fumaric acid esters, aliphatic polyamines and the like.

Suitable secondary amines may include acrylates and methacrylate-modified amines, including both mono- and poly-acrylate modified amines as well as acrylate or methacrylate modified mono- or poly-amines. Acrylate or methacrylate modified amines may include aliphatic amines. Secondary amines may further aliphatic amines, such as a cycloaliphatic diamine. The amine may be provided as an amine-functional resin. Such amine-functional resins may be a relatively low viscosity, amine-functional resin suitable for use in the formulation of high solids polyurea three-dimensional objects. An amine-functional resin may comprise an ester of an organic acid, for example, an aspartic ester-based amine-functional reactive resin that is compatible with isocyanates; e.g., one that is solvent-free. An example of such polyaspartic esters is the derivative of diethyl maleate and 1,5-diamino-2-methylpentane, available commercially from Bayer Corporation, PA under the trade name Desmophen™ NH1220. Other suitable compounds containing aspartate groups may be employed as well.

The polyamine may include polyoxyalkyleneamines. Polyoxyalkyleneamines contain two or more primary amino groups attached to a backbone derived, for example, from propylene oxide, ethylene oxide, or a mixture thereof. Examples of such amines include polyoxypropylenediamine and glycerol tris[poly(propylene glycol), amine-terminated]ether such as those available under the designation Jeffamine™ from Huntsman Corporation.

The amine-functional co-reactive component may also include an aliphatic secondary amine such as Clearlink® 1000, available from Dor-Ketal Chemicals, LLC. The amine-functional co-reactive component may comprise an amine-functional aspartic acid ester, a polyoxyalkylene primary amine, an aliphatic secondary amine, or a combination of any of the foregoing.

In addition to the polyisocyanates and polyamines described above, polythiols may comprise at least one of the co-reactive components. The polythiol may comprise a monomeric polythiol, a polythiol prepolymer, or a combination thereof. A polythiol may comprise a dialkenyl having a thiol functionality, or a polyalkenyl having a thiol functionality.

A polythiol may comprise any suitable thiol-terminated prepolymers or combination of thiol-terminated prepolymers. Examples of suitable thiol-terminated sulfur-containing prepolymers include thiol-terminated polythioethers, thiol-terminated polysulfides, thiol-terminated sulfur-containing polyformals, and thiol-terminated monosulfides.

### B. Polythiol Compositions.

A sulfur-containing prepolymer may comprise a thiol-terminated polythioether. Examples of suitable thiol-terminated polythioether prepolymers are disclosed, for example, in U.S. Pat. No. 6,172,179, which is incorporated by reference in its entirety. A thiol-terminated polythioether prepolymer can comprise Permapol® P3.1E, Permapol® P3.1E-2.8, Permapol® L56086, or a combination of any of the foregoing, each of which is available from PRC-DeSoto International Inc.

Examples of suitable dithiols may include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethylsulfide, methyl-substituted dimercaptodiethylsulfide, dimethyl-substituted dimercaptodiethylsulfide, dimercaptodioxaoctane, 1,5-dimercapto-3-oxapentane, and a combination of any of the foregoing.

Examples of suitable polythiols may include 1,2,3-propanetrithiol, 1,2,3-benzenetrithiol, 1,1,1-butanetrithiol, heptane-1,3-7-trithiol, 1,3,5-triazine-2,4-6-trithiol, isocyanurate-containing trithiols, and combinations thereof, as disclosed in U.S. Application Publication No. 2010/0010133, and the polythiols described in U.S. Pat. Nos. 4,366,307; 4,609,762; and 5,225,472. Combinations of polyfunctionalizing agents may also be used. Examples of suitable polythiol polyfunctionalizing agents include pentaerythritol tetra(3-mercapto-propionate) (PETMP), trimethylol-propane tri(3-mercaptopropionate) (TMPMP), glycol di(3-mercaptopropionate) (GDMP), tris[2-(3-mercapto-propionyloxy) ethyl]isocyanurate (TEMPIC), di-pentaerythritol hexa(3-mercaptopropionate) (di-PETMP), tri(3-mercaptopropionate) pentaerythritol, triethylolethane tri-(3-mercaptopropionate), and combinations of any of the foregoing.

### C. Polyalkenyl Compositions.

Polyalkenyls may also comprise at least one of the co-reactive components. A polyalkenyl may comprise any suitable polyalkenyl prepolymer or combination of polyalkenyl prepolymers. A polyalkenyl prepolymer may comprise an alkenyl-terminated sulfur-containing prepolymer, which can be prepared, for example by reacting a dialkenyl compound with a thiol-terminated sulfur-containing prepolymer as described herein. A polyalkenyl may comprise a monomeric dialkenyl or combination of monomeric dialkenyls.

Examples of suitable polyalkenyls may include triallyl cyanurate (TAC), triallylisocyanurate (TAIC), 1,3,5-triallyl-1,3,5-triazinane-2,4,6-trione, 1,3-bis(2-methylallyl)-6-methylene-5-(2-oxopropyl)-1,3,5-triazinone-2,4-dione, tris(allyloxy)methane, pentaerythritol triallyl ether, 1-(allyloxy)-2,2-bis((allyloxy)methyl)butane, 2-prop-2-ethoxy-1,3,5-tris(prop-2-enyl)benzene, 1,3,5-tris(prop-2-enyl)-1,3,5-triazinane-2,4-dione, and 1,3,5-tris(2-methylallyl)-1,3,5-triazinane-2,4,6-trione, 1,2,4-trivinylcyclohexane, and combinations of any of the foregoing.

A polyalkenyl may comprise a polyalkenyl ether or a combination of polyalkenyl ethers. Examples of suitable bis(alkenyl)ethers include divinyl ether, ethylene glycol divinyl ether (EG-DVE), butanediol divinyl ether (BD-DVE), hexanediol divinyl ether (HD-DVE), diethylene glycol divinyl ether (DEG-DVE), triethylene glycol divinyl ether (TEG-DVE), tetraethylene glycol divinyl ether, and cyclohexanedimethanol divinyl ether.

D. Polyepoxide compositions.

A polyepoxide or combination of polyepoxides may comprise at least one of the co-reactive components. A polyepoxide can be monomeric, a prepolymer, or a combination thereof. Examples of suitable polyepoxides may include hydantoin diepoxide, a diglycidyl ether of bisphenol-A, a diglycidyl ether of bisphenol-F, a novolac-type polyepoxide, epoxidized unsaturated phenolic resins, dimer acid-based epoxy resins, and combinations of any of the foregoing.

### E. Polyol Compositions

A polyol or a combination of polyols may comprise at least one of the co-reactive components. A polyol can be monomeric, a prepolymer, or a combination thereof. Examples of suitable polyols may include diols, triols, carbonate diols, polyether polyols, polyester polyols, polyethylene oxide, polyethylene glycol, polypropylene glycol, polyvinyl alcohol, and combinations of any of the foregoing.

### F. Michael Addition Compositions.

Certain co-reactive compositions provided by the present disclosure may employ Michael addition reactive components. Co-reactive compositions employing a Michael addition curing chemistry may comprise a Michael donor compound and a Michael acceptor compound. In instances where Michael addition comprises 1,4 addition of nitrogen nucleophiles, the addition may be referred to as an Aza-Michael reaction or addition.

The Michael donor compound may comprise a Michael donor monomer, a Michael donor prepolymer, or a combination thereof. Michael donors may include amines, hydroxy group containing oligomers or polymers, acetoacetates, malonates, thiols, and combinations of any of the foregoing.

The Michael acceptor compound can comprise a Michael acceptor monomer, a Michael acceptor prepolymer, or a combination thereof. A Michael acceptor group refers to an activated alkenyl group such as an alkenyl group proximate to an electron-withdrawing group such as a ketone, nitro, halo, nitrile, carbonyl, or nitro group. Examples of Michael acceptor groups include vinyl ketone, vinyl sulfone, quinone, enamine, ketimine, aldimine, oxazolidine, acrylate, acrylate esters, acrylonitrile, acrylamide, maleimide, alkylmethacrylates, vinyl phosphonates, and vinyl pyridines.

Suitable examples of catalysts for Michael addition chemistries include tributylphosphine, triisobutylphosphine, tri-tertiary-butylphosphine, trioctyl phosphine, tris(2,4,4-trimethylpentyl)phosphine, tricyclopentylphosphine, tricyclohexalphosphine, tri-n-octylphosphine, tri-n-dodecylphosphine, triphenyl phosphine, and dimethyl phenyl phosphine.

Examples of suitable Michael donors, Michael acceptors, and catalysts are shown below in Table 2.

TABLE 2
Examples of Michael donors, Michael acceptors, and catalysts

| Michael donors | Michael acceptors | Catalysts |
|---|---|---|
| Acetylacetonates | Methacrylates | Strong bases such as DBU, |
| | | DBN, TMG, TMP, TBD |
| | | (MFC) |
| Malonates | Cyanoacrylates | Nucleophilic catalysts such |
| | | as dimethylphenylphosphine |
| Nitroalkanes | Vinyl ethers | Tetrabutylammonium |
| | | fluoride |
| Any other active | Vinylpyridine | |
| methylene | | |
| | Any α,β-unsaturated | |
| | carbonyl | |

The co-reactive components may react with one another at moderate temperatures, such as about 140° C. or less, about 100° C. or less, about 60° C. or less, about 50° ° C. or less, about 40° C. or less, about 30° C. or less, or about 25° C. or less. The co-reactive components may react with one another at ambient temperatures, such as 20° C. to 28° ° C.

Further details regarding the present co-reactive compositions and their chemistries are disclosed in PCT/IB2018/056254 (published as WO 2019/035099), assigned to the assignee of the present disclosure, which is expressly incorporated by reference herein.

Any of the co-reactive compositions may be used to form the components of structural modules or modular walls as described herein. Furthermore, combinations of co-reactive compositions may be used within the structural modules. Different components of the structural modules may be made from different co-reactive compositions, and the same component may comprise different layers, segments, and/or concentrations of different co-reactive compositions.

The structural modules as described herein may be made of any polymeric material, such as the products of the co-reactive compositions described above. The structural modules may be composed of biobased materials and/or recycled/recyclable materials as well. For example, a component of the structural modules may comprise a recycled construction material and/or a recycled coating material, wherein the recycled materials may have been used in various structures, coatings, or other objects before being used in the structural modules. Additionally, any of the components of the structural modules as described herein may be composed of poly(butylene adipate-co-terephthalate) (PBAT), polybutylene succinate, bio-based polyethylene, bio-based polypropylene, polyhydroxyalkanoates, starch-containing polymer compounds, or any other biobased, recyclable, and/or degradable material and combinations and copolymers thereof. Additionally, any of the co-reactive compositions as described herein may comprise biobased, recyclable, and/or degradable materials, such as succinic acid, 2,5-furandicarboxylic acid, 3-hydroxypropionic acid, glycerol, sorbitol, xylitol, levulinic acid, itaconic acid, 3-hydroxybutyrolactone, glutamic acid, glutaric acid, aspartic acid, ethanol, butanediols, acetic acid, acrylic acid, lactic acid, adipic acid, lactic acid, p-xylene, isobutanol, isoprene, furfurals, triacetic acid lactone, and combinations thereof.

### II. Additives

The formulations of the present disclosure may further include various additives, such as rheology modifiers (e.g., silica or other fillers), flow control agents, plasticizers, thermal stabilizers, UV stabilizers, wetting agents, dispersing auxiliaries, deformers, fillers, reactive diluents, flame retardants, catalysts, pigments, solvents, adhesion promoters, and combinations of any of the foregoing.

An additive or combination of additives can be used to control and/or facilitate a three-dimensional printing operation, including mixing and extrusion. For example, an additive can control the viscosity, mixing, hydrophobicity, hydrophilicity, rheology, or a combination of any of the foregoing.

A filler may comprise, for example, an inorganic filler, an organic filler, a low-density filler, an electrically conductive filler, or a combination of any of the foregoing. A filler may also comprise ground construction materials.

Inorganic fillers useful in compositions provided by the present disclosure may include carbon black, calcium carbonate, precipitated calcium carbonate, calcium hydroxide, hydrated alumina (aluminum hydroxide), fumed silica, silica, precipitated silica, silica gel, and combinations of any of the foregoing.

Organic fillers useful in compositions provided by the present disclosure may include thermoplastics, thermosets, or a combination thereof. Examples of suitable organic fillers include epoxies, epoxy-amides, ethylene tetrafluoroethylene copolymers, polyethylenes, polypropylenes, polyvinylidene chlorides, polyvinylfluorides, tetrafluoroethylene, polyamides, polyimides, ethylene propylenes, perfluorohydrocarbons, fluoroethylenes, polycarbonates, polyetheretherketones, polyetherketones, polyphenylene oxides, polyphenylene sulfides, polyether sulfones, thermoplastic copolyesters, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing.

Further examples of suitable organic fillers include polyamides, such as polyamide 6 and polyamide 12, polyimides, polyethylene, polyphenylene sulfides, polyether sulfones, polysulfones, polyethylimides, polyvinyl fluorides, thermoplastic copolyesters, and combinations of any of the foregoing.

### III. Structural Modules

As described above, the structural modules of the present disclosure may be composed of a 3D printed polymer through a co-reactive printing process comprising reacting a first reactive compound with a second reactive compound. The structural modules may be composed of any polymer formed from the reaction of two compounds, such as polyurea, polyurethane, an epoxy-amine product, a Michael addition product, or any combination thereof.

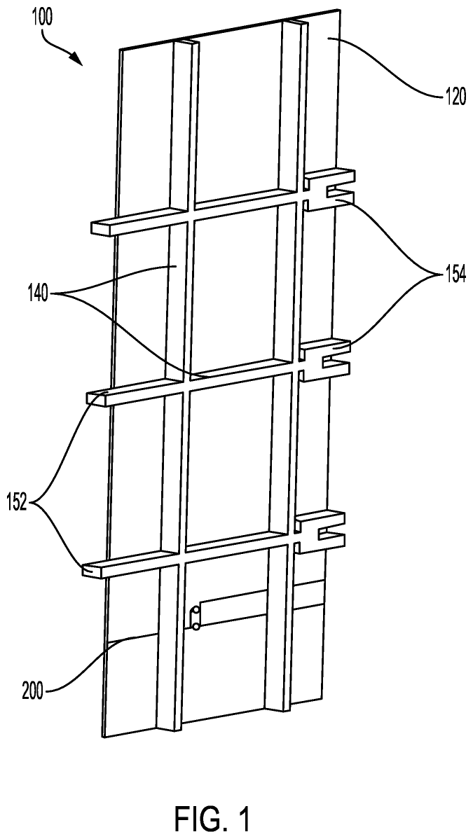

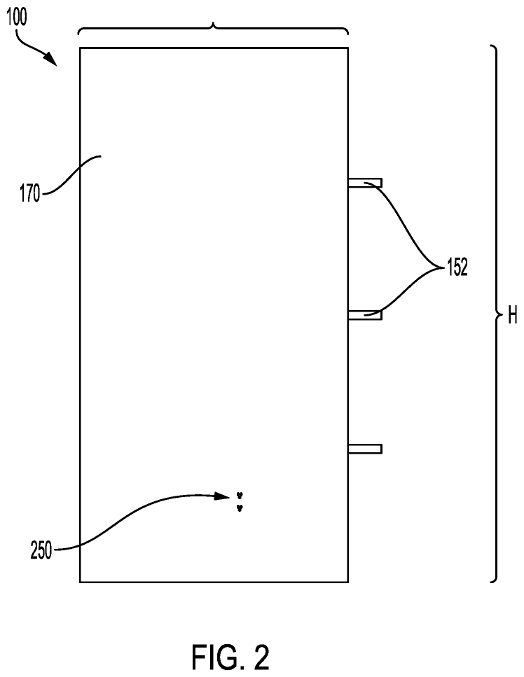

Referring first to FIGS. 1-3, a structural module 100 is shown. Structural module 100 may also be referred to as a module, a modular wall or wall panel, for example. While structural module 100 is illustrated as a modular wall or wall panel, it should be understood that structural module 100 may be a building block (e.g., a cinderblock or brick), a structural frame, a beam, or any other object or component that may be used to form a structure or building. One structural module 100 may be coupled to another structural module 100, to multiple structural modules 100, and/or to any other structural element or object to form a structure or a building. Structural module 100 may be the primary support structure for a building, and/or may be combined with other structural elements such as foundations, frames, beams, walls, floors, ceilings, reinforcing members, or any other standard construction features.

Structural module 100 comprises a main body 120, an external layer 170, a number of structural supports 140, and a number of connection features 152, 154. Structural module 100 may also comprise an electrical circuit 200 and an electrical interface 250. Main body 120 may also be referred to as a drywall layer or a central layer. Main body 120 comprises a first surface 122 and a second surface 124 opposite the first surface. Structural supports 140 and connection features 152, 154 may be coupled to or integral to the second surface 124 of main body 120, and external layer 170 may couple to or be integral to the first surface 122 of main body 120. First surface 122 may be referred to as an outer surface and second surface 124 may be referred to as an inner surface.

Main body 120 may have a height H and a width W, wherein H and W may each independently be 0.1 feet, 0.5 feet, 1 foot, 2 feet, 3 feet, 4 feet, 5 feet, 6 feet, 7 feet, 8 feet, 9 feet, 10 feet, 11 feet, 12 feet, 13 feet, 14 feet, 15 feet, 16 feet, 17 feet, 18 feet, 19 feet, 20 feet, or any range including any two of those values as endpoints. Stated differently, main body 120 may have an area of 0.01 sq. feet, 0.1 sq. feet, 0.5 sq. feet, 1 sq. foot, 2 sq. feet, 5 sq. feet, 10 sq. feet, 15 sq. feet, 20 sq. feet, 30 sq. feet, 40 sq. feet, 50 sq. feet, 75 sq. feet, 100 sq. feet, 125 sq. feet, 150 sq. feet, 175 sq. feet, 200 sq. feet, 225 sq. feet, 250 sq. feet, 275 sq. feet, 300 sq. feet, 325 sq. feet, 350 sq. feet, 375 sq. feet, 400 sq. feet, or any range including any two of these values as endpoints. Additionally, main body 120 may have a thickness of 0.1 inches, 0.2 inches, 0.25 inches, 0.3 inches, 0.4 inches, 0.5 inches, 0.6 inches, 0.75 inches, 0.8 inches, 0.9 inches, 1 inch, 1.25 inches, 1.5 inches, 1.75 inches, 2.0 inches, 2.25 inches, 2.5 inches, or any range including any two of those values as endpoints. Main body 120 may be generally rectangular in shape and may lie substantially within a plane. Main body 120 may comprise angles, and/or curves and may be any shape.

Stated differently, H and W may each independently be 0.05 m, 0.1 m, 0.5 m, 1 m, 1.5 m, 2 m, 2.5 m, 3 m, 3.5 m, 4 m, 4.5 m, 5 m, 5.5 m, 6 m, 6.5 m, 7 m, or any range including any two of those values as endpoints. Stated differently, main body may have an area of 0.01 m², 0.05 m², 0.1 m², 0.5 m², 1 m², 2 m², 3 m², 4 m², 5 m², 10 m², 15 m², 20 m², 25 m², 30 m², 35 m², 40 m², or any range including any two of those values as endpoints. Alternatively, main body may have an area of 0.01 in², 0.05 in², 0.1 in², 0.5 in², 1 in², 6 in², 10 in², 20 in², 50 in², 100 in², or any range including any two of those values as endpoints. Additionally, main body 120 may have a thickness of 1 mm, 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, or any range including any two of those values as endpoints.

Structural supports 140 are generally configured to provide structural support to main body 120 and/or to any other features coupled to or supported by main body 120. Structural supports 140 may also be referred to as studs, stud supports, or framing. Structural supports 140 may extend vertically along a length of main body 120 from a lower end to an upper end, and/or horizontally across a width of main body 120 from a first side to a second side. Structural module 100 may also only comprise vertically oriented structural supports 140. Structural supports 140 may also extend only partially across any portion of main body 120. Structural supports 140 may be studs, similar to wooden studs often used in construction. Structural supports 140 may comprise any shape or structure to provide structural support to structural module 100, and may have any shaped cross-section, such as a rectangle, square, hexagon, triangle, semicircle, or any other shape. Structural supports 140 may form any pattern on main body 120, such as hexagonal patterns, triangular patterns, and/or diagonal patterns, and may extend in any direction along main body 120. Additionally, any number of structural supports 140 may be used in structural module 100. Structural module 100 may comprise 1, 2, 3, 4, 5, 6, 7, 8, or more structural supports 140. Structural supports 140 may also be continuous and may not be defined as individual supports. Structural supports 140 may have similar dimensions to standard wood studs, such as a 2×4. Structural supports 140 may have a width and/or a depth of 0.5 inches, 1 inches, 1.5 inches, 2 inches, 2.5 inches, 3 inches, 3.5 inches, 4 inches, 4.5 inches, 5 inches, or any range including any two of those values as endpoints. Stated differently, structural supports 140 may have a width and/or a depths of 10 mm, 15 mm, 20 mm, 30 mm, 40 mm, 50 mm, 60 mm, 70 mm, 80 mm, 90 mm, 100 mm, 110 mm, 120 mm, 130 mm, or any range including any two of those values as endpoints. Depending on their orientation, structural supports 140 may have a height less than or equal to the height H or the width W of main body 120. Additionally, structural supports 140 may extend beyond the extent of main body 120 and may couple with other structural modules 100 or other structural elements.

### A. Structural Supports

Structural supports 140 may be integral with main body 120 and/or connection features 152, 154, or may be coupled separately to main body 120 and/or connection features 152, 154. Main body 120, 140, and connection features 152, 154 may be formed from one additive manufacturing process, wherein any of the components may be printed together as one piece from a co-reactive 3D printing process. In embodiments where structural supports 140 is not integral with main body 120 and/or connection features 152, 154, structural supports 140 may be coupled to main body 120 and/or connection features 152, 154 through adhesives, screws, bolts, nails, rivets, connective joints, hinges, latches, locking mechanisms, clasps, hooks, welds, or any other suitable coupling device or system.

### B. Connection Features

As shown best in FIG. 1, structural module 100 comprises a number of connection features 152, 154. Connection features may also be referred to as coupling features or connection systems. As illustrated, connection features 152 comprise a protrusion to be received within a recession of connection features 154. Accordingly, one structural module 100 may be coupled to another structural module 100 through connection features 152, 154 by inserting connection features 152 of one structural module 100 into the connection features 154 of another structural module 100. Connection features 154 may comprise protrusions and connection features 152 may comprise recesses. Additionally, each of connection features 152, 154 may comprise both protrusions and recesses such that portions of connection features 152 are received within portions of 154, and portions of connection features 154 are received by within portions of connection features 152. Furthermore, while connection features 152 and connection features 154 may be shaped or sized differently and/or in a complimentary fashion, connection features 152 and connection features 154 may be shaped similarly or identically. Connection features 152, 154 may comprise any systems or devices configured to connect or couple any number of structural module 100 together, such as screws, bolts, nails, rivets, hinges, latches, locking mechanisms, claps, hooks, as well as any connective joints such as butt joints, half lap joints, tongue and groove joints, mortise and tenon joints, biscuit joints, pocket joints, dado joints, rabbet joints, dovetail joints, box joints, and any combination thereof. Furthermore, connection features 152, 154 may comprise adhesives or complimentary surface textures or features to improve adhesion or coupling between connection features 152, 154 and/or between multiple structural modules 100. Connection features 152, 154 may form a nominal and/or connection or coupling, and may require additional coupling features, such as those described above, to securely couple structural modules 100 together.

Structural module 100 may comprise any number of connection features 152, 154 in any location on structural module 100. Structural module 100 may comprise a number of connection features 152, 154 on a first side and a second side of structural module 100, corresponding to a left and a right side or vice versa, such that multiple structural modules may be coupled together horizontally. Structural module 100 may comprise a number of connection features 152, 154 proximate a top side and a bottom side of structural module 100, such that multiple structural modules may be coupled together vertically. Connection features 152, 154 may also be angled or curved to couple together structural modules 100 together at an angle relative to one another, such as at corners. Structural modules 100 may be coupled together generally parallel to one another such that multiple structural modules 100 may form a wall, floor, ceiling, or a plane in general. Structural modules 100 may also be coupled together generally perpendicular to one another, or at any angle to one another to form corners or curved/angled walls. Structural modules 100 may be coupled together in a combination of configurations to form a fully enclosed or partially enclosed room, building, or any other structure.

Connection features 152, 154 may extend beyond the extent of main body 120, only one of connection features 152 or 154 may extend beyond the extent of main body 120, or neither of connection features 152, 154 may extend beyond the extent of main body 120, and another connection feature may be used to couple together connection features 152 and 154. Some structural modules 100 may also not comprise connection features 152 and/or 154, for example if a structural module 100 is configured to be an end piece of a structure (e.g., the last modular wall or wall panel in a non-enclosed structure), it may not comprise connection features 152 or 154.

Connection features 152, 154 may be integral with structural supports 140 and/or main body 120, or may be coupled separately to main body 120 and/or structural supports 140, as described above. In embodiments where main body 120 is not integral with main body 120 and/or structural supports 140, connection features 152, 154 may be coupled to main body 120 and/or structural supports 140 through adhesives, screws, bolts, nails, rivets, connective joints, hinges, latches, locking mechanisms, clasps, hooks, welds, or any other suitable coupling device or system.

Connection features 152, 154 and structural supports 140 may be coupled to or integral with main body 120 on second surface 124 of main body 120. Connection features 152, 154 and structural supports 140 may also independently be positioned within the thickness of main body 120, or proximate/on first surface 122 of main body 120.

### C. External Layer

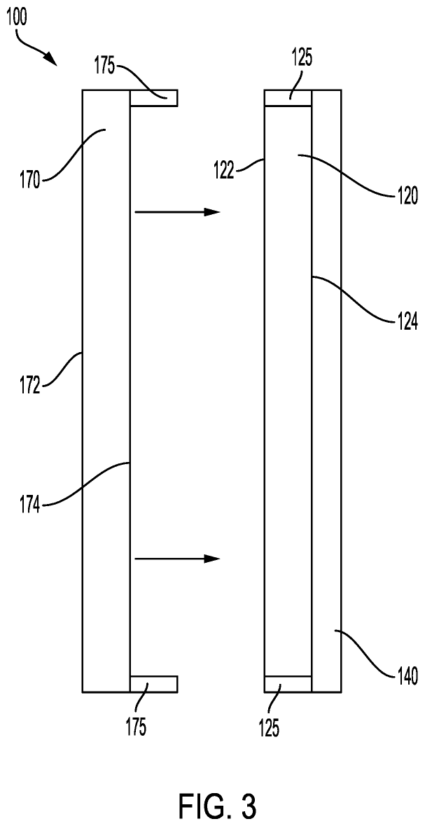

External layer 170 of structural module 100 may be configured to be an outwardly facing layer of structural module 100, and may also be referred to as a façade, a surface layer, a textured surface, or a finishing layer. External layer 170 may be a removable surface feature from a modular wall or a wall panel and may provide similar aesthetic features to paint or wallpaper. As shown best in FIG. 3, external layer 170 of structural module 100 comprises a first surface 172, a second surface 174, and a number of external layer connection features 175. External layer connection features 175 are configured to couple external layer 170 to main body 120. Main body 120 may comprise complimentary external layer connection features 125. External layer 170 may be configured to be attachable and/or detachable from main body 120. Stated differently, external layer 170 may be fixedly or removably coupled to main body 120. Main body 120 may be placed as a structural component, and external layer 170 may be coupled to main body 120 at a later time. External layer connection features 175 may be protrusions configured to be received by external layer connection features 125 which may be recessions. External layer connection features 175 may be recessions and external layer connection features 125 may be protrusions. Both external layer connection features 175 and external layer connection features 125 may comprise recessions and protrusions so portions of external layer connection features 125 are received by external layer connection features 175, and portions of external layer connection features 175 are received by external layer connection features 125. External layer connection features 175, 125 may comprise any systems or devices configured to connect or couple external layer 170 and main body 120 together, such as screws, bolts, nails, rivets, hinges, latches, locking mechanisms, claps, hooks, as well as any connective joints such as butt joints, half lap joints, tongue and groove joints, mortise and tenon joints, biscuit joints, pocket joints, dado joints, rabbet joints, dovetail joints, box joints, and any combination thereof. Furthermore, external layer connection features 175, 125 may comprise adhesives or complimentary surface textures or features to improve adhesion or coupling between connection features 175, 125 and/or between external layer 170 and main body 120. For example, first surface 122 of main body 120 may comprise a texture or pattern configured to interface with a texture or pattern on second surface 174 of external layer 170. An adhesive or other coating may be applied to first surface 122 of main body 120 and/or second surface 174 of external layer 170 to influence adhesion between external layer 170 and main body 120.

External layer 170 may have similar or the same dimensions as main body 120. External layer 170 may have a height H and a width W, wherein H and W may each independently be 0.1 feet, 0.5 feet, 1 foot, 2 feet, 3 feet, 4 feet, 5 feet, 6 feet, 7 feet, 8 feet, 9 feet, 10 feet, 11 feet, 12 feet, 13 feet, 14 feet, 15 feet, 16 feet, 17 feet, 18 feet, 19 feet, 20 feet, or any range including any two of those values as endpoints. Stated differently, external layer 170 may have an area of 0.01 sq. feet, 0.1 sq. feet, 0.5 sq. feet, 1 sq. foot, 2 sq. feet, 5 sq. feet, 10 sq. feet, 15 sq. feet, 20 sq. feet, 30 sq. feet, 40 sq. feet, 50 sq. feet, 75 sq. feet, 100 sq. feet, 125 sq. feet, 150 sq. feet, 175 sq. feet, 200 sq. feet, 225 sq. feet, 250 sq. feet, 275 sq. feet, 300 sq. feet, 325 sq. feet, 350 sq. feet, 375 sq. feet, 400 sq. feet, or any range including any two of these values as endpoints. Additionally, external layer 170 may have a thickness of 0.025 inches, 0.05 inches, 0.075 inches, 0.1 inches, 0.2 inches, 0.25 inches, 0.3 inches, 0.4 inches, 0.5 inches, 0.6 inches, 0.75 inches, 0.8 inches, 0.9 inches, 1 inch, 1.25 inches, 1.5 inches, 1.75 inches, 2.0 inches, 2.25 inches, 2.5 inches, or any range including any two of those values as endpoints. External layer 170 may be similarly shaped to main body 120. For example, external layer 170 may be generally rectangular and flat. External layer 170 may be curved, angled, or otherwise shaped.

Stated differently, H and W may each independently be 0.05 m, 0.1 m, 0.5 m, 1 m, 1.5 m, 2 m, 2.5 m, 3 m, 3.5 m, 4 m, 4.5 m, 5 m, 5.5 m, 6 m, 6.5 m, 7 m, or any range including any two of those values as endpoints. Stated differently, external layer 170 may have an area of 0.01 m², 0.05 m², 0.1 m² 0.5 m², 1 m², 2 m², 3 m², 4 m², 5 m², 10 m², 15 m², 20 m², 25 m², 30 m², 35 m², 40 m², or any range including any two of those values as endpoints. Additionally, external layer 170 may have a thickness of 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, or any range including any two of those values as endpoints.

External layer 170 may be removably couplable to main body 120 as described above, such that a user may attach and remove different embodiments of external layer 170 from the same main body 120. Multiple different embodiments of external layer 170 may also be used on a single main body 120. External layer 170 may also be fixedly coupled to or integral to main body 120.

External layer 170 may comprise any desired surface features for structural module 100. External layer 170 may comprise textures (wood-grain, leather, slate, shea shell, glass, honeycomb, fabric, carbon fiber, etc.), solid colors, mixtures of colors, colored patterns, translucent or clear materials, protruding features (shelves, hooks, etc.), inlets, trims, interactive features, decorative features, or any other desired surface feature or combinations thereof. External layer 170 may also comprise a coating, paint, or any other surface treatment. External layer 170 may be configured to provide desired attributes to structural module 100, such as UV stability, sound dampening, impact resistance, scratch resistance, stain resistance, waterproofing, or any other desired attribute. External layer 170 may be configured to have improved UV stability to maintain color or shading longer than a typically painted surface. External layer 170 may also be configured to have inherent anti-microbial properties. External layer 170 may also be configured to be degradable or recyclable, such that external layer 170 may be removed or replaced, and the external layer 170 that is removed may be recycled or disposed of with reduced environmental or monetary costs. External layer 170 may be fully customizable and able to be designed for multiple different applications, as described herein. Structural module 100 may not comprise external layer 170. Any external features, designs, patterns, attributes etc. as described above with respect to external layer 170 may be integral to main body 120.

### D. Electrical Circuitry

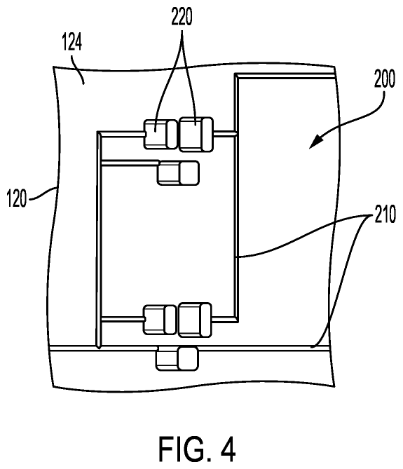

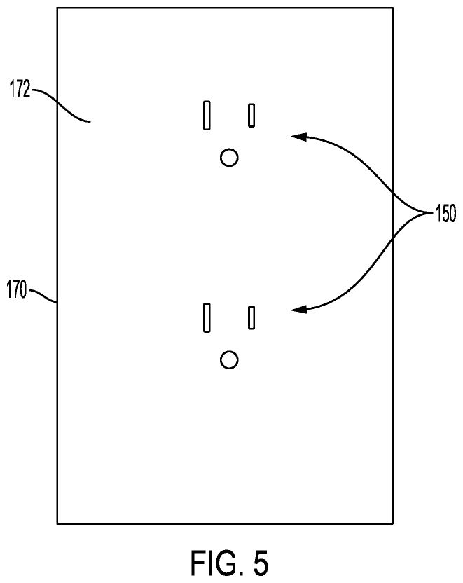

Referring now to FIGS. 1, 2, 4, and 5, structural module 100 may comprise electrical circuit 200 and electrical interface 250. As shown in FIG. 4, electrical circuit 200 may comprise embedded circuit elements 220, as well as electrical connections 210. Electrical connections 210 may comprise a printed conductive material, such as conductive ink (e.g., silver ink), or a conductive polymeric material. Main body 120 may also comprise standard wires embedded in main body 120. Electrical connections 210 are configured to connect with a power source to transmit power from the power source to electrical interface 250. Electrical connections 210 may be configured to connect with other electrical connections 210 on other structural module 100, such that when two or more structural modules are coupled together as described herein, electrical connections 210 on the structural modules 100 may also be coupled together such that electricity may flow between structural modules 100. Electrical circuit 200 and electrical connections 210 may also electrically couple between external layer 170 and main body 120, such that electrical interface 250 may be positioned on first surface 172 of external layer 170. Electrical circuit 200 may be printed on or otherwise embedded in main body 120 on second surface 124 of main body 120, and electrical interface 250 may be on first surface 172 of external layer 170, or on first surface 122 of main body 120. Electrical circuit 200 may also be positioned within the thickness of main body 120. Structural module 100 may also comprise electrical insulation (not shown) to protect electrical circuit 200. Components of structural module 100 may also be composed of a non-conducting material such that components of structural module 100 act as a natural electrical insulator.

Structural module 100 may also comprise features not shown in the illustrated embodiments, such as thermal insulation, electrical insulation, sound dampening features, protective coatings, ventilation, cable housings, pipes, plumbing, gas lines, water lines, as well as interactive features such as windows, doors, switches, wall-décor mounts, thermostats, building controls, closets, entertainment systems, speakers, display screens, home appliances, and any combination thereof.

### IV. Printing Process

As mentioned above, any or all of the components of structural module 100 may be printed through additive manufacturing or 3D printing. Specifically, the components may be printed with ambient reactive extrusion comprising a first reactive compound reacting with a second reactive compound to create a thermoset polymer. Details on printing chemistries may be found in section II herein.

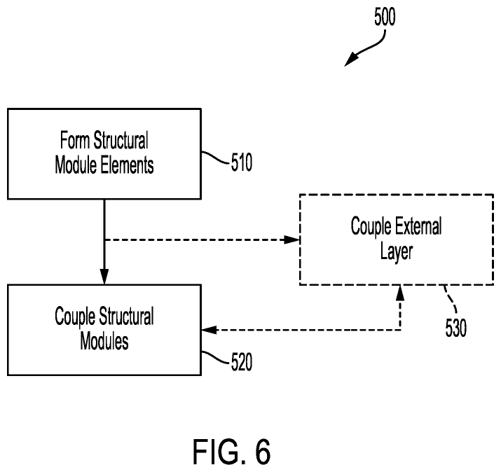

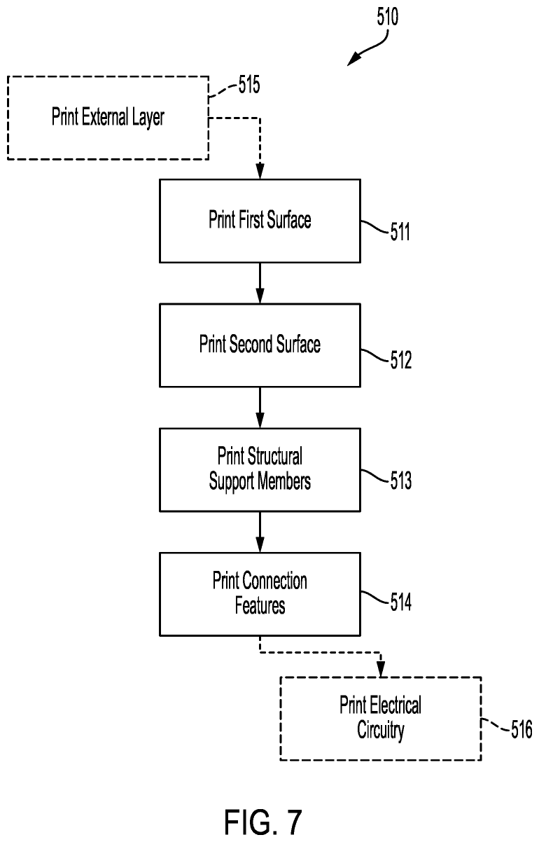

Referring to FIGS. 6 and 7, a building process 500 for forming a structure comprising structural module 100 is shown. The completed structure may also be referred to as a modular wall structure, a modular wall system, a structural module system, a building, or an enclosure. The building process 500 comprises a forming step 510 and a coupling step 520. Building process 500 also comprises an optional coupling external layer step 530, wherein external layer 170 is coupled to main body 120 of structural module 100. As will be described in more detail herein, in forming step 510, the components of structural module 100 are formed, including main body 120, structural supports 140, and connection features 152, 154. Once structural module 100 is formed, at least two structural module 100 may be coupled together to form a structure in coupling step 520. Building process 500 may also comprise coupling step 530 wherein external layer 170 is coupled to main body 120. As shown in FIG. 6, coupling step 130 may occur after forming step 510, or after coupling step 520. Stated differently, external layer 170 may be coupled to main body 120 of structural module 100 before or after structural module 100 is coupled to another structural module 100 to form a structure.

Referring to FIG. 7, the forming step 510 may comprise multiple steps, including printing steps 511, 512, 513, and 514. Forming step 510 may also comprise optional printing steps 515 and 516. Printing step 511 comprises printing first surface 122 of main body 120, and printing step 512 comprises printing second surface 124 of main body 120. Together, steps 511 and 512 form main body 120. As mentioned previously, main body 120 may be embodied as a wall or a wall panel, and printing steps 511 and 512 may form the wall by printing a surface of the wall and adding material to add thickness to the wall up to a second surface. Printing step 511 and printing step 512 may be combined into a single step such that a single printing step may create both the first surface 122 and the second surface 124 of main body 120. Printing step 513 comprises printing structural supports 140, and printing step 514 comprises printing connection features 152, 154. The timing of each of the printing steps 511-514 may be such that the components cure together to form one integral piece. The time required to print a given component may be sufficiently long to allow for the majority of the chemical network deposited on a print bed to react, but short enough that each of the layers are not completely reacted and are still able to bond with previous and subsequent layers.

Printing step 515 comprises printing external layer 170, and may be completed independently of printing steps 511-514, since external layer 170 may be removably couplable from main body 120, and may not be present in structural module 100. Printing step 516 comprises printing electrical circuit 200 on structural module 100, and may be carried out with separate equipment and in a separate location than printing steps 511-514.

Any printing step as described herein may be carried out with a printing arm and a printing bed. The printing arm may be fluidly coupled to a reservoir or reservoirs containing the reactive compounds, fillers, pigments, and any other additives to be used to print the components of structural module 100. For example, a printing arm may be fluidly coupled to a first reservoir containing a first reactive component, and a second reservoir containing a second reactive component. The first and second reactive components may be combined in a static mixer before then being extrude through a printing head on the printing arm, wherein the mixed components are deposited onto the printing bed. The printing arm and/or the printing bed may be movable to deposit material in different locations to form structural module 100 into any desired shape or with any desired dimensions. Once deposited, the material may then cure at ambient conditions to for a thermoset polymer composition that makes up any or all of the components of structural module 100.

Any of the printing steps as described herein may be carried out on a desktop additive manufacturing printer, on a large-scale additive manufacturing printer, with a multi-axis arm additive manufacturing printer, and/or with a 3D printing conveyor system.

### A. Multi-Axis Printing Systems

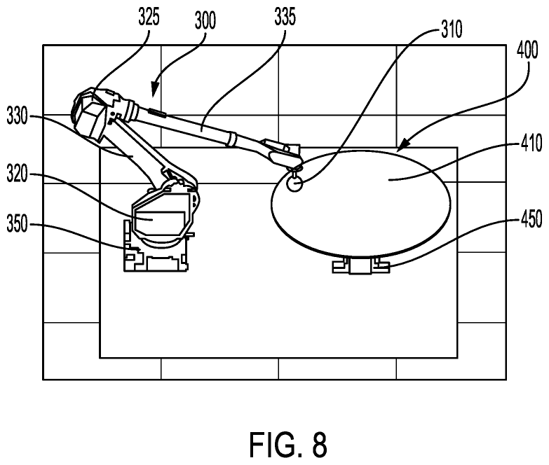

Referring to FIG. 8, a multi-axis printing arm 300 and printing bed 400 are shown. Multi-axis printing arm 300 may be used at any scale, for example at larger scales to print objects too large for a standard desktop printing system. Multi-axis printing arm 300 may be referred to as a robot arm or a robot printer. Multi-axis printing arm 300 comprises a printing arm base 350, printing arm pivots 320, 325, printing arm shafts 330, 335, and a printing head 310. Multi-axis printing arm 300 is configured such that printing head 310 may move along 6 axes of movement: three translational axis and three rotational axis. Accordingly, multi-axis printing arm 300 may also be referred to as a 6-axis robot arm. Printing arm base 350 may be coupled to a foundation, floor, table, or other surface and may be configured to support the remaining components of multi-axis printing arm 300. Printing arm pivots 320, 325 are configured to rotate printing arm shafts 330, 335 around at least one axis at each pivot. Printing arm shafts 330, 335 may be extendable to increase movement range of multi-axis printing arm 300. The combination of movements from pivots 320, 335 and shafts 330, 335 may allow for printing head 310 to move in any direction. Printing head 310 may also be configured to rotate relative to shaft 335, and multi-axis printing arm 300 may comprise an additional pivot between printing head 310 and shaft 335. Multi-axis printing arm 300 may also comprise a number of motors to actuate movement of each component of multi-axis printing arm 300.

Reservoirs for the printing components may be fluidly coupled to any components of multi-axis printing arm 300 to bring the reactive components from the reservoir to printing head 310. Multi-axis printing arm 300 may comprise a number of pumps to direct fluids from reservoirs to printing head 310. Multi-axis printing arm 300 may also comprise a mixing device, such as a static mixer, to mix components from reservoirs together before depositing on printing bed 400.

Printing bed 400 comprises a bed surface 410 and a bed base 450. Bed surface 410 is configured to receive deposited material from multi-axis printing arm 300. Printing bed 400 may also comprise a number of pivots, shafts, actuators, and/or motors to actuate movement of printing bed 400. Printing bed 400 may be tilted, rotated, and/or translated relative to printing arm base 350 and/or printing head 310. The combination of movement of multi-axis printing arm 300 and printing bed 400 may allow for precise manufacturing of parts through additive manufacturing over a large range of shapes and sizes.

Any of the components of structural module 100 may be printed such that they are hollow, that they comprise internal support structures, or that they are solid, depending on the desired attributes of structural module 100, as well as production times and costs. Additionally, any components of structural module 100 may be printed or formed with more than one material. Components of structural module 100 may be layered with multiple materials to provide various structural, functional, and/or aesthetic attributes to the components. Multiple printers may also be used to print any or all components of structural module 100.

### V. Structural Module Applications and Properties

Forming structural modules, walls, panels, or building blocks, such as structural module 100, through additive manufacturing may reduce the time, labor, monetary costs, environmental costs, and/or waste associated with typical construction methods. Forming structures with structural module 100 may also provide additional customizability and improved performance when compared to traditional construction methods and systems.

Each component of structural module 100 may comprise different materials, printing techniques/conditions, and/or features to bring about different attributes to each component. Main body 120 may be manufactured to provide increased rigidity, structural supports 140 may be manufactured to provide increased toughness/durability/load bearing, and external layer 170 may be manufactured to provide improved surface finishes.

Main body 120 may have any desired material properties. Main body 120 may have a Young's modulus of at least 600 MPa, at least 700 MPa, at least 800 MPa, at least 900 MPa, at least 1000 MPa, at least 1100 MPa, at least 1200 MPa, at least 1300 MPa, at least 1500 MPa, at least 2000 MPa, or any range including any two of these values as endpoints. Main body 120 may have a maximum tensile strength of at least 20 MPa, at least 30 MPa, at least 40 MPa, at least 50 MPa, at least 60 MPa, at least 70 MPa, at least 80 MPa, at least 90 MPa, at least 100 MPa, or any range including any two of these values as endpoints. Main body 120 may have a tensile strain at break of at least 1%, at least 5%, at least 10%, at least 15%, at least 20%, at least 25%, at least 30%, at least 35%, at least 40%, or any range including any two of these values as endpoints. Main body 120 may have a glass transition temperature of at least 70° C., at least 80° C., at least 90° C., at least 100° C., at least 110° C., at least 120° C., at least 130° C., at least 140° C., or any range including any two of these values as endpoints.

Structural supports 140 may have any desired material properties. Structural supports 140 may have a Young's Modulus of at least 600 MPa, at least 700 MPa, at least 800 MPa, at least 900 MPa, at least 1000 MPa, at least 1100 MPa, at least 1200 MPa, at least 1300 MPa, at least 1500 MPa, at least 2000 MPa, or any range including any two of these values as endpoints. Structural supports 140 may have a maximum tensile strength of at least 20 MPa, at least 30 MPa, at least 40 MPa, at least 50 MPa, at least 60 MPa, at least 70 MPa, at least 80 MPa, at least 90 MPa, at least 100 MPa, or any range including any two of these values as endpoints. Structural supports 140 may have a tensile strain at break of at least 5%, at least 10%, at least 15%, at least 20%, at least 25%, at least 30%, at least 35%, at least 40%, at least 50%, or any range including any two of these values as endpoints. Structural supports 140 may have a glass transition temperature of at least 70° C., at least 80° C., at least 90° C., at least 100° C., at least 110° C., at least 120° C., at least 130° C., at least 140° C., or any range including any two of these values as endpoints.

External layer 170 may have any desired material properties. External layer 170 may have a Young's Modulus of at least 100 MPa, at least 200 MPa, at least 300 MPa, at least 400 MPa, at least 500 MPa, at least 600 MPa, at least 700 MPa, at least 800 MPa, at least 900 MPa, at least 1000 MPa, or any range including any two of these values as endpoints. External layer 170 may have a maximum tensile strength of at least 20 MPa, at least 30 MPa, at least 40 MPa, at least 50 MPa, at least 60 MPa, at least 70 MPa, at least 80 MPa, at least 90 MPa, at least 100 MPa, or any range including any two of these values as endpoints. External layer 170 may have a tensile strain at break of at least 5%, at least 10%, at least 15%, at least 20%, at least 25%, at least 30%, at least 35%, at least 40%, at least 50%, or any range including any two of these values as endpoints. External layer 170 may have a glass transition temperature of at least 70° C., at least 80° C., at least 90° C., at least 100° C., at least 110° C., at least 120° C., at least 130° C., at least 140° C., or any range including any two of these values as endpoints.

Structural module 100 may be used to construct any structure. For example, structural module 100 may be used to construct temporary buildings (e.g., temporary shelters, pop-up buildings), permanent buildings (e.g., houses, commercial buildings, recreational spaces, warehouses, factories), temporary displays (e.g., trade show displays, store displays), room dividers, camping shelters, cubicles, or any other structure. As mentioned previously, structural module 100 may be used alone or in combination with other structural systems/components such as foundations, flooring, ceilings, roofing, doors, windows, frames, and any other construction system known in the art. As mentioned herein, structural module 100 may be a modular wall or a wall panel and may be connected together to form a larger wall or a modular wall system, which may be part of or all of a structure, building, or display.

Structural module 100 may also be configured to interface with appliances, electronic devices, HVAC systems, plumbing, pipes, and existing structures. Structural module 100 and any components may be configured to provide functionality such as thermal insulation, electrical insulation, stain resistance, easy cleanability, scratch resistance, flame resistance, UV resistance/stability, sound damping, weight reduction, visual/decorative customization, increased structural design flexibility, improved strength, improved durability, self-healing, and any other desired functionality. Any potential improvements indicated may be in comparison to typical wall structures composed of painted drywall and wood studs. In comparison to traditional structural/construction techniques and systems, producing structures with structural module 100 may reduce time, labor, cost, and waste required to form a structure.

Additionally, repairing structural module 100 may be easier than repairing a standard wall or other structural component. Structural module 100, a surface of main body 120, and/or external layer 170 may comprise additional attributes such as scratch resistance, dent resistance, stain resistance, easy cleanability, anti-microbial properties, flame resistance, thermal insulation, electrical insulation, acoustic insulation, and general improved durability. Any of the mentioned properties of components of structural module 100 may be achieved through material selection, combination of materials, manufacturing processes, and/or coatings. A thermoset repair kit may be used to allow a user to mix a first reactive component and a second reactive component together and, while the thermoset mixture is curing, patch scratches or holes in structural module 100. A repair system may be sold as a pre-packaged kit to a user, wherein the kit may comprise cleaning materials, mixing materials, reactive components, filler, and/or patching or coating materials within the kit.

A method of forming an external layer as part of a structural module comprising a textured surface may include applying a coreactive composition using ambient coreactive extrusion over a textured template; at least partially curing the applied coreactive composition; and removing the textured template from the at least partially cured applied coreactive composition to provide a part comprising a textured surface. The textured template may include a release layer. The method may further include applying a release layer over the textured template before applying the coreactive composition. The method may further include applying a surface coating over the textured template, before applying the coreactive composition. Applying the surface coating may include spray coating. The method may further include, after applying the surface coating, allowing the applied surface coating to dry and to cure at least partially. Applying the coreactive composition may include applying adjacent beads of the coreactive composition using three-dimensional printing. Applying the coreactive composition may include applying horizontally adjacent beads of the coreactive composition using three-dimensional printing. Applying a coreactive composition may include applying a first layer of a coreactive composition. Applying a coreactive composition may include applying two or more layers of a coreactive composition overlying the first layer. Each of the layers may independently include a coreactive composition. Each of the layers may include the same coreactive composition. At least one of the layers may include a coreactive composition that is different than at least one other layer. Adjacent overlying layers of a coreactive composition may include the same curing chemistry. Adjoining overlying layers of a coreactive composition may include functional groups capable of reacting with functional groups of the adjacent layer. The method may further include forming the at least partially cured applied coreactive composition into a shape of a part. The textured template may include a textured release paper. The textured template may be heated to a temperature greater than 25° C. The textured surface may be characterized by a surface roughness Sa from 2 μm to 200 μm. The textured template may include a smooth texture. The textured surface may be characterized by a smooth surface having a surface roughness Sa less than 2 μm. Applying a coreactive composition may include applying a first coreactive composition to the textured template to provide a first layer and applying a second coreactive composition onto the first layer to provide a second layer. The first coreactive composition and the second coreactive composition may include the same constituents and the same amounts of the constituents. The first coreactive composition and the second coreactive composition may include different constituents and/or amounts of the same constituents. The first coreactive composition and the second coreactive composition may have the same curing chemistry. The first coreactive composition and the second coreactive composition may be configured to chemically bond to each other. Applying may include extruding, such as additive manufacturing, such as three-dimensional printing. The method may further include, after removing the textured template, forming the at least partially cured coreactive composition into a shape of a part. The method may further include, after at least partially curing the coreactive composition forming the textured template and the coreactive composition into a shape of a part. Another method of forming a part having a textured surface includes applying a coreactive composition to fabricate a part; and while the applied coreactive composition is partially cured, embossing a surface of the partially cured coreactive composition using a textured template to provide a part having a textured surface.

### EXAMPLES

Embodiments provided by the present disclosure are further illustrated by reference to the following examples. It will be apparent to those skilled in the art that many modifications, both to materials, and methods, may be practiced without departing from the scope of the disclosure.

### Example 1—External Layer

In this example the first component of the wall to be printed is the external layer (also referred to as a façade). The external layer will be customizable and incorporate textured surfaces and designer colors depending on the desired aesthetics. A veneer of ambient reactive extrusion (ARE) additive manufacturing (AM) printed material printed separately from the rest of the wall and installed onto the wall as a façade at the job site. The dimensions of these facades can range from dimensions consisting of Y′×Z′ where Y and Z are equal to but not limited to the range between 1′ and 20′ with a thickness between 0.1″ and 2″. These facades will be thin and lightweight to facilitate easy installation. Compared to traditionally mudding and painting walls, these printed facades would open up additional textures, perfect color matching, color transitions and additional features such as enhanced wash-ability, variable touch profiles, and enhanced mechanical properties.

This section will be printed from a strong, non-flexible thermoset formulation including but not limited to polyurea, polyurethane, epoxy-amine, and Aza-Michael addition chemistries. Potential physical property ranges for this section can be found in Table 3.

TABLE 3
Physical properties of the exterior facade section for modular
architectural walls.

| Physical Property | Value Range |
|---|---|
| Young's Modulus (MPa) | >600 |
| Maximum Tensile Strength (MPa) | >40 |
| Tensile Strain at Break (%) | >20 |
| Glass Transition Temperature (° C.) | >90 |

The texture and color of these modular façades will be fully customizable. Textures that can be obtained through this process include but are not limited to leather, slate, sea shell, glass, wood-grain, honeycomb, fabric, carbon fiber, and synthetic texture. Colors will be obtained through pigments added to the ARE AM materials used to print the façades. In addition to solid colors, clear/translucent, multi-colored, or color transition façades could be created through changing the pigment package used during the printing process.

### Example 2—Main Body Components

In this example, the main body (which may also be referred to as a drywall component) of the structural module is made. A printed section of the overall modular architectural wall may act as the replacement for traditional drywall. During manufacturing, this section will be printed first with a slow gelling material face down consisting of dimensions within the range of Y′×Z′ where Y and Z are equal to but not limited to the range between 1′ and 20′ and with a thickness between ¼″ and 2″. A dam and fill method may be utilized to increase the production efficiency of the manufacturing or add mechanical structures to the front of the wall for the addition of aesthetic facades. Compared to traditionally installed drywall, this section will add improved mechanical properties, quicker production speed, and easier installation.

The structural drywall component of the wall will be printed from a rigid and tough thermoset formulation including but not limited to polyurea, polyurethane, epoxy-amine, and Aza-Michael addition chemistries. Physical property ranges for this section can be found in Table 4.

TABLE 4
Physical properties of the drywall section for modular architectural
walls.

| Physical Property | Value Ranges |
|---|---|
| Young's Modulus (MPa) | >1000 |
| Maximum Tensile Strength (MPa) | >50 |
| Tensile Strain at Break (%) | >10 |
| Glass Transition Temperature (° C.) | >90 |

This component of the wall would provide the foundation for the prefabricated modular wall and serve as the main structural component of the wall. Along the top and bottom of this structural drywall component may exist floor trim and ceiling molding. This trim and molding would be connected either through chemical bonding between the thermosets at the time of print or through mechanical means (Screws, nails, etc.). If the trim and/or molding is to be connected via mechanical means, connection points (ex. screw holes) could be printed into the fixtures or processed with a CNC machine during manufacture of the modular wall to ensure perfect alignment. Mechanical connections for the molding would allow for easy switching between new trim and molding aesthetics. In addition to interchangeable trim and molding, the structural drywall component would also connect to the interchangeable wall façades described in Example 1. The connections to the interchangeable façades would be mechanical joints. Examples of these joints include tongue and groove and/or dovetail. These mechanical joints could be located within the floor and ceiling trim and molding or printed into the upper and lower sections of the structural drywall component itself.

### Example 3—Structural Supports and Connection Features

In this example, the structural supports (which may be referred to as studs, support studs, or framing) and connection features (which may be referred to as modular connections) of the structural module will be formed. A printed section of the overall modular structure may act as the replacement for traditional wooden framing and contributes to the support structure of the wall. Dimensions of this framing will mimic traditional (2″×L) wooden boards where L can range from 2″ to 20′, but ultimately the shape and layout of the framing structure will be optimized for both mechanical strength and lightweight properties. During manufacturing, this section will be printed on top of the structural drywall component so that it is covalently bonded to the drywall structural component, as well. Compared to traditionally installed framing, this section will add improved mechanical properties, longevity, and ease of installation through interlocking structures.

This section will be printed from a tough thermoset formulation including but not limited to polyurea, polyurethane, epoxy-amine, and Aza-Michael addition chemistries. This section may utilize alternating print layers ranging from rigid to tough material properties in order to optimize the overall strength of the frame. Physical property ranges for this section can be found in Table 5.

TABLE 5
Physical properties of the structural support stud/framing component
of modular architectural walls.

| Physical Property | Value Range |
|---|---|
| Young's Modulus (MPa) | >1000 |
| Maximum Tensile Strength (MPa) | >50 |
| Tensile Strain at Break (%) | >20 |
| Glass Transition Temperature (° C.) | >90 |

This section comprises the structural integrity of the wall that the structural drywall component is connected to. This framing will be mechanically advantaged over traditional framing by being lighter and more load resistant due to its higher tensile strength and strain. The lightweight aspect of the structural framing and drywall component enables the product to be handled more easily on construction sites. Each section of frame will begin with one female connection and end with one male connection. This will enable each of the framed sections to be locked into place on a construction site with ease. Connections will be made special for corners and other unique wall shapes. For wall sections that include doors, windows, or other features, the layout of the framing can be modified to allow for the installation and reinforcement of these features.

### Example 4—Structural Framework

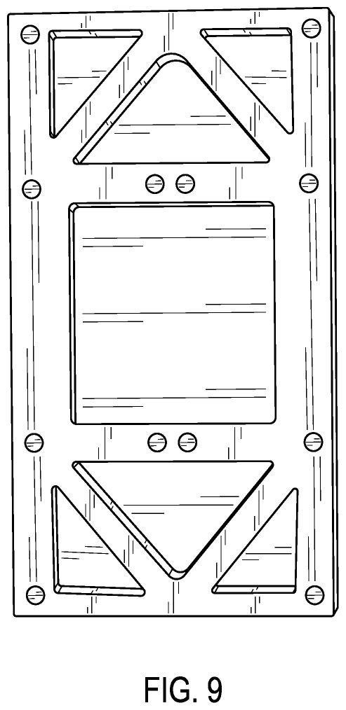

In this example, a modular wall section was manufactured by printing a base layer and subsequently printing structural framework on top of the base layer (see FIG. 9). The modular wall section was created using a two component Viscotec extruder mounted upon a Lulzbot Taz 6. As these structures were printed together, they become chemically bonded. The structural framework printed as part of the modular wall section is described in Example 3 above. The printed structural framework, represented by the raised section in FIG. 9, was custom-designed to optimize the structural strength of the modular wall section. The printed modular wall section is one solid piece and needs no additional installation steps other than what is needed for traditional wooden framework. The printed structural framework has the material properties listed in Table 6. Young's modulus, maximum tensile strength, and tensile strain at break are determined according to ASTM D638. Flexural Strength, flexural strain, and flexural modulus are determined according to ISO 178.

TABLE 6
Physical properties of the structural framework.

| | | Maximum | Tensile | | | |
|---|---|---|---|---|---|---|
| | Young's | Tensile | Strain at | Flexural | Flexural | Flexural |
| | Modulus | Strength | Break | Strength | Strain | Modulus |
| Description | (MPa) | (MPa) | (%) | (MPa) | (%) | (MPa) |
| Structural | 1257 | 46 | 15 | 9 | 5 | 260 |
| Framework | | | | | | |
| Required | >1000 | >35 | <20 | >6 | > or =5 | >200 |
| Range for | | | | | | |
| Structural | | | | | | |
| Framework¹ | | | | | | |

### Example 5—Interchangeable Façade

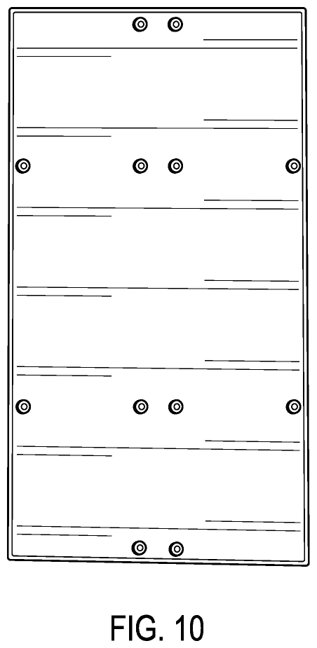

In this example, an interchangeable façade, which may act as the decorative outermost layer, is printed. The interchangeable façade was printed to include coupling elements (e.g., protrusions) configured to join with coupling elements (e.g., recesses) of the structural framework described in Example 4. (see FIG. 10) The coupling elements of the interchangeable façade and the structural framework may be joined, such as removably joined such that the interchangeable façade may be coupled, such as removably coupled, to the structural framework. The connection features depicted in FIG. 10 are slotted holes and pegs sized and located to fit within the slotted holes. The printed interchangeable façade has the material properties listed in Table 7. Young's modulus, maximum tensile strength, and tensile strain at break are determined according to ASTM D638. Flexural Strength, flexural strain, and flexural modulus are determined according to ISO 178.

TABLE 7
Physical properties of the interchangeable fac̨ade.

| | | Maximum | Tensile | | | |
|---|---|---|---|---|---|---|
| | Young's | Tensile | Strain at | Flexural | Flexural | Flexural |
| | Modulus | Strength | Break | Strength | Strain | Modulus |
| Description | (MPa) | (MPa) | (%) | (MPa) | (%) | (MPa) |
| Inter- | 308 | 12 | 142 | 5 | 5 | 167 |
| changeable | | | | | | |
| Fac̨ade | | | | | | |
| Required | >100 | >10 | 20-200 | >4 | > or =5 | >100 |
| Range for | | | | | | |
| Inter- | | | | | | |
| changeable | | | | | | |
| Fac̨ade | | | | | | |

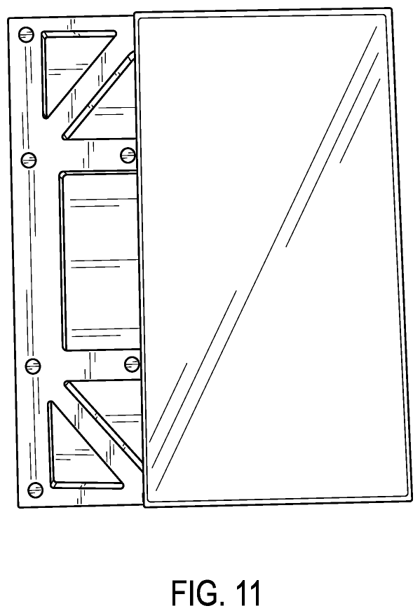

FIG. 11 shows the printed interchangeable façade of Example 5 to be coupled with the structural framework of Example 4. Specifically, the coupling elements of the interchangeable façade on the rear-facing side (not shown in FIG. 11) faces towards the coupling elements of the structural framework on the front-facing side. In this particular example, the surface finish of the interchangeable façade is smooth and slightly reflective.

### Example 6—Textured Façade

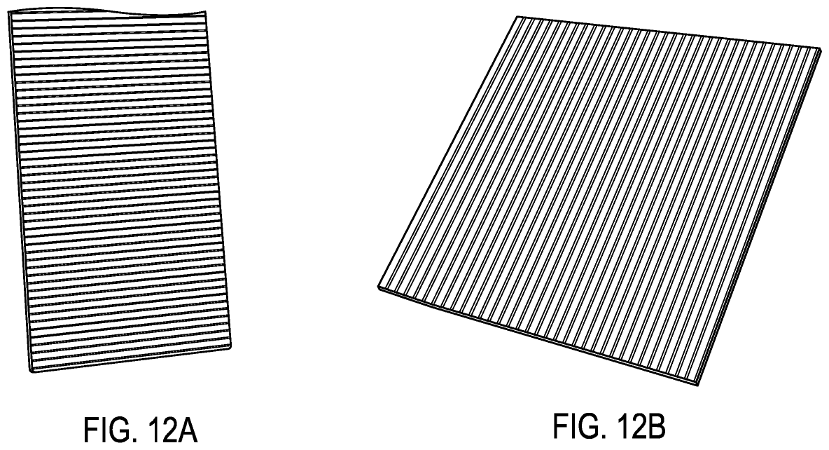

In this example, façades with textured surfaces are printed. Specifically, FIG. 12A shows a façade with a front-facing surface printed with a horizontal wood-grain texture. FIG. 12B shows a façade with a front-facing surface printed with a vertical wood-grain texture. The textured façades were printed by first spraying a textured mold with a mold release spray and followed by printing polyurea of the present disclosure onto the textured mold via a two component Viscotec extruder mounted upon a Lulzbot Taz 6. The polyurea was then cured upon the textured mold. Once cured, the textured façades were then removed from the textured mold.

### Example 7—Connection Features for Structural Modules

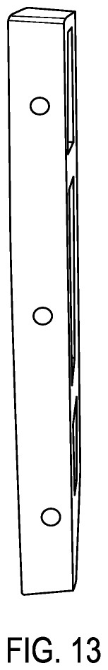

In this example, structural modules with connection features were printed to enable the coupling of structural modules into a larger structure. As depicted in FIG. 13, the connection features printed were slotted peg holes configured to receive and/or join with matching pegs on a neighboring module when coupled. The printed structural module includes connection features multiple sides to allow coupling with neighboring modules from those sides, such as in parallel, perpendicularly, and/or any other an any other angle that a construction design required. The structural modules, when joined together via the connection features, form at least one continuous surface and/or at least one flush surface.

### Example 8—Electrical Circuitry

In this example, electrical circuitry is printed on a structural module described in Example 3. This circuitry is printed to allow access through an electrical outlet printed into the wall structure. Conductive ink is used to print the electrical circuitry. Electrical circuitry printed onto structural modules are configured to connect when the structural models are coupled.

### Example 9—Robotic Printing

In this example, the structures described in Examples 1 to Example 9 are printed using a robotic arm in lieu of a gantry system. Specifically, a two-component extruder system is mounted upon the robotic arm and two reactive compositions are fed from two sources of material to the mixer-extruder. The robotic arm then follows a print path designed to create the structures of Examples 1 to Example 9.

### Example 10—Repair Kits

In this example, repair kits are printed to allow repair to be performed on any of the structures described in the present disclosure. Specifically, a repair kits includes two component mixable systems configured to be applied directly to any damaged parts of the structures described in the present disclosure.

### Example 11—Printed Structural Modules for Building Construction

Printing structural modules using ambient reactive extrusion (ARE) components can allow customization, reduce on-site labor costs, and/or on-site work time. Printed ARE structural modules is used in the construction of an office building. Based on a building layout, multiple modular sections of support structures according to Example 4 is printed using a large gantry system or a robotic arm as described in Example 9. The printed structural modules include sections that are straight, angled, and/or other shaped, with some including connection features as described in Example 7. Some structural modules include electrical circuitry printed on the rea-facing surfaces as described in Example 8. Some structural modules are printed to include specialty materials for enhanced thermal and/or sound insulation properties. Interchangeable façades like those described in Example 5 are printed to be coupled with the support structures. Some of the façades are printed onto textured surfaces as described in Example 6 to create textured surfaces. The interchangeable facades are printed to interconnect with the structural modules. The printed structural modules and the facades, once cured, are configured to be connected together at the construction site for reduced on-site time and labor cost.

### Example 12—Polyurea Coreactive Composition for Printing External Layers

A coreactive composition for ambient coreactive extrusion of external layers was prepared by combining and mixing an isocyanate component and an amine component. Each component was prepared by combining the constituent materials in a Max 300 L DAC cup a mixed using a Flacktek Speedmixer®.

The constituent materials of the isocyanate component and the amine component are presented in Table 8 and Table 9, respectively.

The individual components were transferred to an Optimum® cartridge for three-dimensional printing by ambient coreactive extrusion suing a Viscotec® 2K extruder mounted to a Lulzbot® Taz 6 robotic assembly.

TABLE 8
Isocyanate Component.

| Material | Amount (wt. %) |
|---|---|
| Isocyanate-terminated polybutadiene | 91 |
| resin | |
| MW about 2,000 | |
| NCO functionality about 2 | |
| Catalyst | 6 |
| Fumed silica | 3 |

TABLE 9
Amine Component.

| Material | Amount (wt. %) |
|---|---|
| Polyetheramine | 36.15 |
| MW 5,000 Daltons | |
| Average AHEW 952 g/eq | |
| Polyamine | 2.50 |
| Amine value 199-203 mg KOH/g | |
| Equivalent weight 276 | |
| Polyamine | 26.00 |
| Amine value 240-248 mg KOH/g | |
| Equivalent Weight 234 | |
| Aliphatic diamine chain extender | 10.95 |
| Equivalent Weight 161 | |
| Talc | 4.82 |
| Polyamide thixotrope | 3.10 |
| Barium sulfate | 4.82 |
| Sodium-potassium alumina | 4.82 |
| silicate | |
| Pigment | 1.00 |
| 0.2 g/cc | 3.24 |
| Fumed silica | 3.24 |

### Example 13—Textured Surfaces Using Ambient Coreactive Extrusion

In this example, the coreactive polyurea composition described in Example 12 was used to fabricate external layers having textured surfaces.

A calibrated Viscotec® 2K extruder with the “long nozzle” (MKH-03-16S) mounted on a Lulzbot® Taz 6 three-dimensional printing gantry was used to print the coreactive polyurea composition. The coreactive polyurea composition was printed at a print speed of 3 mL/min at a volume ratio of 1.5:1 (isocyanate component:amine component).

Textured templates were flattened and secured onto a print bed before printing. The textured templates were textured release paper available, for example, from Sappi.

After printing was complete, the printed external layers including the release paper and the printed coreactive polyurea composition were exposed to 160° F. (71.1° C.) for 2 days to fully cure the polyurea composition. After the polyurea was fully cured, the printed external layers were allowed to cool to room temperature before removing the textured release paper. The surface roughness (Sa) was measured using a Keyence VR 3200 Macroscope. Optical and digitized profile images were also obtained.

### Example 14—Leather-Textured Surfaces Using Ambient Coreactive Extrusion

In this example, external layers with surfaces having leather textures were prepared using the material and methods described in Examples 12 and 13. The surface roughness Sa for the leather textures was 10 μm to 40 μm.

### Example 15—Patterned-Textured Surfaces Using Ambient Coreactive Extrusion

In this example, external layers with patterned and textured surfaces were prepared using the material and methods described in Examples 12 and 13. The printed surface of an external layer with a synthetic texture showed an Sa of 21.96 μm, and the printed surface of another external layer with a grid texture shows an Sa of about 8 μm to 26 μm.

### Example 16—Natural-Textured Surfaces Using Ambient Coreactive Extrusion

In this example, external layers with natural patterned surfaces were prepared using the material and methods described in Examples 12 and 13. A printed surface of an external layer with a natural woodgrain showed an Sa of 14.53 μm, and a printed surface of another external layer with a natural slate texture showed an Sa of 6.2 μm.

### Example 17—Large Area Textured Surfaces Using Ambient Coreactive Extrusion

In this example, large area external layers with textured surfaces were prepared into 10 inch×10 inch pieces. The constituent materials for the isocyanate component and the amine component are provided in Tables 8 and 9, respectively.

TABLE 8
Isocyanate Component.

| Material | Amount (wt. %) |
|---|---|
| Aliphatic polyisocyanate resin | 92.2 |
| NCO equivalent weight 179 | |
| NCO content 23.5 wt. % | |
| Fumed silica | 7.8 |

TABLE 9
Amine Component.

| Material | Amount (wt. %) |
|---|---|
| Polyamine | 83.44 |
| Amine value 199-203 mg KOH/g | |
| Equivalent weight 276 | |
| UV Stabilizer | 0.86 |
| Hindered amine light stabilizer | 1.72 |
| Pigment | 3.91 |
| Pigment | 0.98 |
| Fumed silica | 9.09 |

The large-area external layers were printed using ambient coreactive extrusion method as described in Example 13.

### Example 18—Three-Part Structural Module

In this example, an external layer of Example 1, a main body of Example 2, and a structural support of Example 3 are printed such that the external layer may be coupled to a first surface of the main body and the structural support may be coupled to a second surface of the main body.

### Example 19—Two-Part Structural Module

In this example, an external layer of Example 1 and a structural framework of Example 4 are printed such that the external layer may be coupled to a surface of the structural framework.

### Example 20—Three-Part Structural Module with Interchangeable Façade

In this example, an interchangeable façade of Example 5, a main body of Example 2, and a structural support of Example 3 are printed such that the interchangeable façade may be coupled to a first surface of the main body and the structural support may be coupled to a second surface of the main body.

### Example 21—Two-Part Structural Module with Interchangeable Façade

In this example, an interchangeable façade of Example 5 and a structural framework of Example 4 are printed such that the interchangeable façade may be coupled to a surface of the structural framework.

### Example 22—Three-Part Structural Module with Textured Façade

In this example, an textured façade of Example 6, a main body of Example 2, and a structural support of Example 3 are printed such that the textured façade may be coupled to a first surface of the main body and the structural support may be coupled to a second surface of the main body.

### Example 23—Two-Part Structural Module with Textured Façade

In this example, an textured façade of Example 6 and a structural framework of Example 4 are printed such that the textured façade may be coupled to a surface of the structural framework.

### Example 24—Three-Part Structural Module with Leather-Textured Façade

In this example, a leather-textured façade of Example 14, a main body of Example 2, and a structural support of Example 3 are printed such that the leather-textured façade may be coupled to a first surface of the main body and the structural support may be coupled to a second surface of the main body.

### Example 25—Two-Part Structural Module with Leather-Textured Façade

In this example, a leather-textured façade of Example 14 and a structural framework of Example 4 are printed such that the leather-textured façade may be coupled to a surface of the structural framework.

### Example 26—Three-Part Structural Module with Patterned-Textured Façade

In this example, a patterned and textured façade of Example 15, a main body of Example 2, and a structural support of Example 3 are printed such that the patterned and textured façade may be coupled to a first surface of the main body and the structural support may be coupled to a second surface of the main body.

### Example 27—Two-Part Structural Module with Patterned-Textured Façade

In this example, a patterned and textured façade of Example 15 and a structural framework of Example 4 are printed such that the patterned and textured façade may be coupled to a surface of the structural framework.

### Example 28—Three-Part Structural Module with Natural-Textured Façade

In this example, a natural-textured façade of Example 16, a main body of Example 2, and a structural support of Example 3 are printed such that the natural-textured façade may be coupled to a first surface of the main body and the structural support may be coupled to a second surface of the main body.

### Example 29—Two-Part Structural Module with Natural-Textured Façade

In this example, a natural-textured façade of Example 16 and a structural framework of Example 4 are printed such that the natural-textured façade may be coupled to a surface of the structural framework.

### ASPECTS OF THE INVENTION

The invention can be further defined by one or more of the following aspects.

Aspect 1. A method of manufacturing a structural module comprising: printing a first surface of the structural module; printing a second surface of the structural module opposite the first surface, wherein the first surface and the second surface are substantially planar; and printing a plurality of structural support members on the second surface and projecting outwardly from the second surface, wherein at least one of the printing steps is carried out by reacting a first reactive component with a second reactive component, and the plurality of structural support members are of a composition chemically different from the first surface.

Aspect 2. The method of aspect 1, wherein at least one of: the method further comprises the step of coupling an external layer to the first surface of the structural module; and at least one of the first surface and the second surface has an area of at least 6 in².

Aspect 3. The method of aspect 2, wherein at least one of the first surface and the external layer comprise at least one external layer coupling feature, and the step of coupling is carried out through the at least one external layer coupling feature.

Aspect 4. The method of any one of aspects 1-3, further comprising the step of printing an electrical circuit on the second surface of the structural module.

Aspect 5. The method of aspect 4, further comprising the step of printing an outlet on the first surface of the structural module, wherein the outlet is electrically coupled to the electrical circuit.

Aspect 6. The method of aspects 4 or 5, wherein the electrical circuit is printed with conductive (e.g., silver) ink.

Aspect 7. The method of any one of aspects 4-6, wherein the electrical circuit extends to an edge of the structural module and is configured to be electrically coupled with a second electrical circuit on the second structural module.

Aspect 8. The method of any one of aspects 1-7, wherein the plurality of structural support members comprises studs: extending from a lower end of the structural module to an upper end of the structural module; configured to allow the structural module and one or more neighboring structural modules be oriented in a grid-like pattern; configured to allow the structural module and one or more neighboring structural modules be oriented in a polygonal pattern; or configured to allow the structural module and one or more neighboring structural modules be oriented in a hexagonal pattern.

Aspect 9. The method of any one of aspects 1-8, wherein at least one component of the structural module is composed of a polymer selected from the group consisting of: a polyurea, a polyurethane, a polysulfide, a polythioether, an actinic radiation-cured product, an epoxy-amine product, a condensation reacted product, and a Michael addition product.

Aspect 10. The method of any one of aspects 1-9, wherein each printing step is carried out with a movable printing arm, a static printing arm, a movable printing bed, and/or a static printing bed.

Aspect 11. The method of aspect 10, wherein the movable printing arm comprises a multi-axis robotic arm.

Aspect 12. The method of any one of aspects 1-11, wherein at least one component of the structural module comprises at least one of a recycled construction material and a recycled coating material.

Aspect 13. The method of any one of aspects 1-12, further comprising the step of printing a plurality of connection features on the second surface of the structural module, wherein the connection features are configured to interface with a second plurality of connection features on a second structural module.

Aspect 14. A structural module comprising: a first surface; a second surface opposite the first surface, wherein at least one of the first and second surfaces have an area of at least 6 in²; and a plurality of structural support members coupled to the second surface wherein the first surface, the second surface, and the structural support members, are each composed of a polymer and produced from an additive manufacturing process in which a first reactive compound reacts with a second reactive compound.

Aspect 15. The structural module of aspect 14, wherein the structural module comprises a modular wall.

Aspect 16. The structural module of aspect 14 or aspect 15, wherein the first surface comprises an external layer, and at least one of the first surface and the external layer comprises at least one of: (a) a surface attribute selected from the group consisting of scratch resistance, dent resistance, stain resistance, anti-microbial properties, flame resistance, thermal insulation, acoustic insulation, and electrical insulation; and (b) a surface texture selected from the group consisting of: wood-grain, leather, slate, shea shell, glass, honeycomb, fabric, carbon fiber, synthetic texture, and combinations thereof.

Aspect 17. The structural module of any one of aspects 14-16, further comprising a plurality of connection features coupled to the second surface, wherein the plurality of connection features is configured to couplet the structural module to a second structural module.

Aspect 18. The structural module of any one of aspects 14-17, further comprising an electrical circuit printed onto the second surface and configured to deliver electricity to an electrical outlet on the first surface.

Aspect 19. A modular wall system comprising: a first wall extending from a first end to a second end, the first wall comprising: a first surface; a second surface opposite the first surface of the first wall; a plurality of first structural supports coupled to the first surface of the first wall; and a plurality of first connection features coupled to the first surface of the first wall; and a second wall extending from a first end to a second end, the second wall comprising: a first surface; a second surface opposite the first surface of the second wall; a plurality of second structural supports coupled to the first surface of the second wall; and a plurality of second connection features coupled to the first surface of the second wall; wherein the plurality of first connection features is adapted to couple with the plurality of second connection features proximate the first end of the first wall and the second end of the second wall.

Aspect 20. The modular wall system of aspect 19, wherein the first surface of the first wall is flush with the first surface of the second wall.

Aspect 21. The modular wall system of aspects 19 or 20, wherein the first wall is parallel to the second wall.

Aspect 22. The modular wall system of aspects 19 or 20, wherein the first wall is perpendicular to and forms a corner with the second wall.

Aspect 23. The modular wall system of any one of aspects 19-22, wherein each of the first wall and the second wall are formed from an additive manufacturing process comprising reacting a first reactive component with a second reactive component.

Aspect 24. A repair kit for repairing damage to the modular wall system of any of aspects 19-23 comprising the first reactive compound and the second reactive compound, wherein the first and second reactive compounds are configured to be mixed and applied to damaged areas of the structural module.

Aspect 25. A structural module comprising: a main body comprising: a first surface; and a second surface opposite the first surface, wherein at least one of the first and second surfaces have an area of at least 6 in²; and a plurality of structural support members configured to be coupled to the second surface; wherein the main body and the plurality of structural support members are each composed of a polymer and produced from an additive manufacturing process in which a first reactive compound reacts with a second reactive compound.

Aspect 26. The structural module of aspect 25, further comprising: an external layer comprising a first plurality of connection features; wherein: the main body further comprises a second plurality of connection features; and the main body is configured to be coupled to the external layer by at least coupling the first plurality of connection features with the second plurality of connection features.

Whereas particular examples of this invention have been described above for purposes of illustration, it will be evident to those skilled in the art that numerous variations of the details of the present invention may be made without departing from the invention as defined in the appended claims.

1. A method of manufacturing a structural module comprising:
printing a structural module comprising a first surface and a second surface opposite the first surface, wherein the first surface and the second surface are substantially planar; and
printing a plurality of structural support members on the second surface and projecting outwardly from the second surface, wherein at least one of the printing steps is carried out by reacting a first reactive component with a second reactive component, and the plurality of structural support members are of a composition chemically different from the first surface.

2. The method of claim 1, wherein at least one of:
(a) the method further comprises the step of coupling an external layer to the first surface of the structural module; and
(b) at least one of the first surface and the second surface has an area of at least 6 in².

3. The method of claim 2, wherein at least one of the first surface and the external layer comprise at least one external layer coupling feature, and the step of coupling is carried out through the at least one external layer coupling feature.

4. The method of claim 1, further comprising the step of printing an electrical circuit on the second surface of the structural module.

5. The method of claim 4, further comprising the step of printing an outlet on the first surface of the structural module, wherein the outlet is electrically coupled to the electrical circuit.

6. The method of claim 4, wherein the electrical circuit is printed with conductive ink.

7. The method of claim 4, wherein the electrical circuit extends to an edge of the structural module and is configured to be electrically coupled with a second electrical circuit on the second structural module.

8. The method of claim 1, wherein the plurality of structural support members comprises studs:
extending from a lower end of the structural module to an upper end of the structural module;
configured to allow the structural module and one or more neighboring structural modules be oriented in a grid-like pattern;
configured to allow the structural module and one or more neighboring structural modules be oriented in a polygonal pattern; or
configured to allow the structural module and one or more neighboring structural modules be oriented in a hexagonal pattern.

9. The method of claim 1, wherein at least one component of the structural module is composed of a polymer selected from the group consisting of: a polyurea, a polyurethane, a polysulfide, a polythioether, an actinic radiation-cured product, an epoxy-amine product, a condensation reacted product, and a Michael addition product.

10. The method of claim 1, wherein each printing step is carried out with at least a movable printing arm, a static printing arm, a movable printing bed, or a static printing bed.

11. The method of claim 10, wherein the movable printing arm comprises a multi-axis robotic arm.

12. The method of claim 1, wherein at least one component of the structural module comprises at least one of a recycled construction material and a recycled coating material.

13. The method of claim 1, further comprising the step of printing a plurality of connection features on the second surface of the structural module, wherein the connection features are configured to interface with a second plurality of connection features on a second structural module.

14. A structural module comprising:
a first surface;
a second surface opposite the first surface, wherein at least one of the first and second surfaces have an area of at least 6 in²; and
a plurality of structural support members coupled to the second surface wherein the first surface, the second surface, and the structural support members, are each composed of a polymer and produced from an additive manufacturing process in which a first reactive compound reacts with a second reactive compound.

15. The structural module of claim 14, wherein the structural module comprises a modular wall.

16. The structural module of claim 14, wherein the first surface comprises an external layer, and at least one of the first surface and the external layer comprises at least one of:
(a) a surface attribute selected from the group consisting of scratch resistance, dent resistance, stain resistance, anti-microbial properties, flame resistance, thermal insulation, acoustic insulation, and electrical insulation; and
(b) a surface texture selected from the group consisting of: wood-grain, leather, slate, shea shell, glass, honeycomb, fabric, carbon fiber, synthetic texture, and combinations thereof.

17. The structural module of claim 14, further comprising a plurality of connection features coupled to the second surface, wherein the plurality of connection features is configured to couplet the structural module to a second structural module.

18. The structural module of claim 14, further comprising an electrical circuit printed onto the second surface and configured to deliver electricity to an electrical outlet on the first surface.

19. A structural module comprising:
a main body comprising:
a first surface; and
a second surface opposite the first surface, wherein at least one of the first and second surfaces have an area of at least 6 in²; and
a plurality of structural support members configured to be coupled to the second surface;
wherein the main body and the plurality of structural support members are each composed of a polymer and produced from an additive manufacturing process in which a first reactive compound reacts with a second reactive compound.

20. The structural module of claim 19, further comprising:
an external layer comprising a first plurality of connection features;
wherein:
the main body further comprises a second plurality of connection features; and
the main body is configured to be coupled to the external layer by at least coupling the first plurality of connection features with the second plurality of connection features.
